(19) United States
(12) Patent Application Publication
(10) Pub. No.: US 2006/0209013 A1
(43) Pub. Date: Sep. 21, 2006

(54) METHOD OF CONTROLLING A MACHINE CONNECTED TO A DISPLAY BY LINE OF VISION

(75) Inventor: Dirk Fengels, Denver, CO (US)

Correspondence Address: Dirk Fengels, Am Chaeferberg 25, Pratteln, 4133, CH

(73) Assignee: Mr. Dirk Fengels, Denver, CO (US)

(21) Appl. No.: 10/907,028

(22) Filed: Mar. 17, 2005

(51) Int. Cl. G09G 5/00

(52) U.S. Cl. 345/156

(57) ABSTRACT

A method of controlling a machine connected to a display comprising an absolute pointing method providing a wearable apparatus (1) including an image sensor (61) worn on an operator's head (58) or ear and adjustable so that the pointing direction (57) of the image sensor (61) is congruent with the operator's focus point on said display (45) when relative head-eye movements are small. A processor (33) analyzes images (103) of the display environment taken by the image sensor (61) and determines the pointing direction (57) of the image sensor with respect to the display outline (50). The wearable apparatus (1) further includes a microphone (8) for initiating actions on said machine by audio commands. Other means for initiating actions includes detecting certain head movements and a special keyboard driver. The method further comprises means for feedback from the wearable apparatus (1) to the machine. A wireless configuration is provided, including a receiver apparatus (42) connected to the machine, where a software driver positions the pointer (51) on the display area (55) and responds to operator commands. Means for facilitating display outline recognition to increase performance and reliability is provided and consists of no more than eight infrared reflective stickers (49) placed around the perimeter of the display area (55) and an infrared source (19) located next to the image sensor (61).

### BACKGROUND OF THE INVENTION

1. Field of Invention

This invention relates to hands-free pointing devices or methods with means for initiating actions on a machine connected to a display, specifically to devices or methods which correlate pointer positioning on a display with line of vision or focus point of the operator.

2. Prior Art

Many machines with a display require user interaction over pointing devices or other input devices. Machines with graphical displays are effectively controlled by pointing devices such as a mouse if the machine is a computer. A mouse enables pointing to certain objects on the screen and initiating an action by pressing a button. However, a mouse is not suited as a text input device, where keyboards are most effective. Operating in an environment such as Microsoft Windows where pointing and initiating actions as well as text input are required, the use of mouse and keyboard is not efficient since the user must frequently switch between the mouse and the keyboard. In addition, although controlling a mouse is an easy task for most people with normal hand-eye coordination, the task of pointing to a certain object can be made more intuitive and also enable people with certain disabilities to use a computer ergonomically. The main purpose of the invention is to improve effectiveness of working in described environment by eliminating the need to switch between pointing and input devices and most of all to make pointing a highly intuitive and precise task to increase overall ergonomics.

Devices and methods have been invented to control a pointer hands-free, specifically by head movement, as well as devices and methods for controlling a pointer on a display by absolute means rather than moving the pointer simply in the direction the pointing device is moved.

The preferred method of absolute pointer control used with this invention was already described in principle and to some extent by U.S. Pat. No. 20,040,048,663. It uses an image sensor to take pictures of the display area where a pointer is controlled to determine the cursor position on the display by relation of the center point of the taken image to the detected outline of the display within said image sensor (pointing direction). Said patent however does not disclose a method of hands-free pointer control (uses buttons) and especially is not correlated to the line of sight or line of vision of the operator.

U.S. Pat. No. 4,565,999 discloses a system for an absolute pointing method by use of at least one radiation sensor and one radiation source that can be used to control a cursor on a display directly by head motions. Said patent requires at least one sensor or source at a fixed position with respect to the display and at least one sensor or source fixed with respect to the head of the operator. The method described in that patent controls a pointer by orientation of the operator's head. No correlation between head orientation and line of vision is made, which may not be perceived as intuitive as positioning the pointer in close proximity or even at the focus point of the operator on the display. The disclosure further describes means for initiating actions by rapid movements such as horizontal and vertical nodding, resulting in a very limited number of possibilities to initiate actions.

U.S. Pat. No. 4,209,255 discloses means for tracking the aiming point on a plane. However, there is no disclosure of hands-free pointer control on a display connected to a machine. There is also no disclosure of means for initiating actions on said machine. The described invention within said patent comprises emitter means positioned on the operator's head as well as sighting means on the head that leads to a complex apparatus required to be worn by the operator. Also, said patent requires photo-responsive means in addition to the sensors worn by the operator that needs to be placed on the display if described plane is a display.

U.S. Pat. No. 5,367,315 uses eye and head movement to control a cursor; however the method only detects direction of eye movement to move the cursor in the same direction and does not detect the absolute line of vision with respect to a display. In addition, no disclosure of means to initiate multiple actions on a computer is made. Also, the operating range is limited to an active area within which the operator must remain.

A variety of head tracking methods exist that use relative head movements to control a pointer. One of these methods was disclosed in U.S. Pat. No. 4,682,159, in which a head tracking method using ultrasound sensors is described. In this specified patent, at least two ultrasonic receivers must be mounted relative to the operator's head in addition to a transmitter in another location. All head tracking methods translating relative head movements into pointer movements suffer from the disadvantage that the pointer position is not directly correlated to the line of vision or focus point of the operator. This requires permanent visual feedback when the pointer is moved and lacks intuitive use because without visual feedback the operator is unaware of and cannot know the current pointer position.

In addition, some head tracking methods use one or multiple stationary sensors affixed with respect to the display that result in increased system complexity and limitations regarding posture and position of the operator with respect to the display due to a limited field of view of the sensors.

In addition, except in U.S. Pat. No. 20,020,158,827, no disclosures have been made regarding means for initiating multiple actions on the machine connected to the display over a microphone by audio commands, in combination with the hands-free pointing device. Examples for sensors used in relative head tracking methods are inertia sensors, cameras, gyroscopic sensors, ultrasound sensors and infrared sensors.

Another example for a relative head tracking method is disclosed in U.S. Pat. No. 6,545,664. This patent also lacks absolute pointer control and correlation between pointer control and line of vision and therefore intuitive use.

Other examples for relative head tracking methods include devices such as TRACKIR from NaturalPoint, Tracker from Madentec Solutions, HeadMouse Extreme from Origin Instruments, SmartNav from Eye Control Technologies Ltd, HeadMaster Plus from Prentke Romich, VisualMouse from MouseVision Inc., QualiEye from QualiLife, and CameraMouse from CameraMouse Inc. These consumer products lack absolute pointer control and direct correlation between pointer control and line of vision. It is considered essential that for intuitive use, direct correlation between line of vision and pointer control is established while maintaining a high degree of accuracy. Although one manufacturer suggests that relative head movements can be made absolute by relating relative movements to a fixed and previously defined position. This method can only constitute a pseudo absolute control and it still lacks correlation to line of vision even if the system were frequently recalibrated. Head translations affect pointer control even if the operator's focus point on the display remains fixed. For those methods using a stationary image sensor, changes in distance from the operator to the screen will change the amplitudes of movements detected by the stationary image sensor and would require recalibration if correlation to line of vision is to be maintained. Further, these consumer products often lack means for initiating a large variety of actions.

There has also been a considerable amount of research conducted using the reflection of light from the eye to detect eye movement and thus allow a person to use his or her eyes to make limited selections displayed on a screen. An example of the utilization of this type of technology is shown in U.S. Pat. No. 4,950,069. Systems of this type, however, require the head to be maintained in a fixed position. They also require software algorithms with significant computational power requirements. The technology employed in U.S. Pat. No. 4,950,069 is based upon considerable research that has been done in the area of recording methods for eye movement and image processing techniques. This research is summarized in two articles published in the periodical “Behavior Research Methods & Instrumentation”: Vol. 7(5), pages 397-429 (1975) entitled “Methods & Designs—Survey of eye movement recording methods”; and Vol. 13(1), pages 20-24 entitled “An automated eye movement recording system for use with human infants”. The basic research summarized in these articles is concerned with accurate eye movement measurement, and is not concerned about utilizing the eye movement to carry out any other functions. In all of these eye movement recording methods, the head must be kept perfectly still. This is a serious disadvantage for the normal user.

More ongoing research in the field of pure eye tracking methods with a camera in proximity of the display is expected.

The invention described in this patent intends to replace pointing devices, such as a computer mouse, by a hands-free pointing method and to outperform prior art regarding intuitive use, accuracy and comfort of use. In order to accomplish these tasks, an absolute pointer control was invented whereby the pointer is controlled by line of vision of the operator and the pointer closely follows the operator's focus point on the display without noticeable delay.

It is an objective of the presented invention to provide intuitive hands-free pointer positioning by line of sight or line of vision and to position the pointer in close proximity of the operator's focus point on the display.

It is another objective to reduce the number of required sensors to one sensor, being an image sensor.

It is another objective to provide means for initiating multiple actions on the machine to be controlled.

A prototype was developed proving the concept, the high degree of intuitive use and accuracy of the invented method as well as the overall attractiveness of this method.

The presented method is intuitive since the user always looks at the pointing target. Compared to other solutions, no feedback is needed to move the pointer onto the target object, since the user is always aware of the exact pointer location, that is, directly where he or she looks. Therefore it is an absolute pointer control and not a relative control as with a regular mouse. Also, the pointer doesn't need to be displayed while the viewpoint of the operator is moving. Therefore, this invention provides significant improvements and overcomes any limitations regarding sensor angle of view and position or posture of the operator that exist when a non-wearable, stationary sensor is used as in some of the prior art. With one limitation, the described invention of pointing indirectly follows the eye movement by following the head movement of a sensor mounted on eye level close to an eye and adjusted to point to the focus point of the operator on the display. Said limitation is that the user must turn his or her head along with the eyes or, in other words, the user must keep relative eye-head movements small. Even with this limitation, the use of such a device is very intuitive since people tend to move their head with their eyes to keep eye movements small and only minor adjustments need to be made to move the pointer onto the target. As with a regular mouse, some training may be needed to get used to a completely new kind of pointing (paradigm shift).

Also, this invention provides means for initiating a variety of actions on the machine connected to the display.

The invention is a highly intuitive, hands-free pointing device for a computer. However, the invention is not limited to computers. It may be used on any machine with a display, or that is connected to a display, requiring user interaction.

Thus, all pointing methods heretofore known suffer from at least one but often multiple of disadvantages:
(1) The use of mouse and keyboard is not very efficient since the user must frequently switch between mouse and keyboard.
(2) Method uses relative pointer control with respect to the display, requiring visual feedback at all times to determine the current pointing position and move pointer onto target; or pointer needs to be moved onto target by head movements that are not directly correlated to line of vision of the operator. Thus, relative pointer control is not highly intuitive.
(3) May cause physiological problems such as carpel tunnel syndrome.
(4) Pointing position is estimated from eye positions captured by a stationary camera, therefore making pointing method not very precise.
(5) The operator's head motion is tracked from an image sensor near the display. It therefore tracks movements in two dimensions only. Thus, head translations are causing the pointer to move even if the line of vision or focus point of the operator on the display remains fixed.
(6) Static sensor position(s) with respect to the display, causing restrictions in the position or freedom of movement and posture of the operator due to a limited field of view of the sensor(s).
(7) Methods using image-processing algorithms to detect certain parameters such as eye positions require a lot of computational power.
(8) Method provides no disclosure of pointer positioning by line of vision of the operator or by the focus point of the operator on the display. Such methods are likely to lack intuitive use and precision.
(9) No hands-free cursor control.
(10) No or limited means for initiating actions on the machine connected to the display where the pointer is controlled.
(11) At least two sensors required, whereby at least one sensor must be fixed to a position with respect to the display where the pointer is controlled.
(12) Sensors are used that are lower performance than charge coupled device (CCD) or CMOS image sensors regarding speed, power consumption, size, weight and resolution and thus precision or sensors are much more expensive.
(13) Precision of methods using non-imaging sensors is often inferior compared to precision attainable with today's high performance low-cost image sensors like the one used in this invention.
(14) Some methods require operator to wear disposable stickers on forehead that are tracked by a stationary camera.
(15) Hand-eye coordination is required.

3. Objects and Advantages

Accordingly, several objects and advantages of the present invention are:
(1) Pointer follows line of sight or line of vision to track focus point of operator.
(2) Operator is always aware of current pointer position even without permanent visual feedback.
(3) Only one sensor is required. A radiation source may be used in combination with few small reflective adhesive stickers to increase reliability and reduce computational power requirements.
(4) Hands-free pointer control making controlling a machine with display very efficient since no switching between pointing and text input device is required.
(5) Hands-free pointing method helps preventing physiological problems such as carpel tunnel syndrome or repetitive strain injuries (RSI) and enables humans with certain disabilities such as amyotrophic lateral sclerosis (ALS) or quadriplegia to ergonomically control a machine having a display such as a personal computer.
(6) Absolute cursor control, i.e. cursor is located where pointer is pointing, not cursor moves certain distance when pointer is moved a certain distance.
(7) Only small restrictions regarding the operator's position relative to the display or regarding the posture of operator because sensor is following pointing direction and an algorithm compensates for rotations around the sensor's pointing axis.
(8) Highly intuitive because pointer follows line of vision and appears in vicinity of focus point if relative head-eye movements are small. This requires no visual feedback other than for fine control over target.
(9) Very precise due to high resolution and high overall performance of current low-cost CMOS or CCD image sensors.
(10) Small apparatus that can be worn on an ear and is less restrictive and uncomfortable than a headset.
(11) Means for initiating a variety of actions on the machine connected to a display.
(12) No hand-eye coordination required.

### SUMMARY

It is a primary objective of this invention to provide an intuitive and precise hands-free method of controlling a machine that is connected to a display, such as a computer with monitor or a gaming device connected to a TV. To also eliminate the need to periodically switch between text input device and pointing device.

The method provides means to initiate a wide variety of actions on the machine, such as CLICK, DOUBLECLICK, DRAG, DROP, SCROLL, OPEN, CLOSE, etc., triggered by operator commands and means to control a pointer on the display by line of vision of the operator. The latter means comprises a wearable apparatus worn on the operator's head or on an ear, as used in a preferred embodiment. It further comprises an image sensor with adjustable pointing direction mounted in proximity to an eye of the operator. A processor continuously analyzes images taken of the display area by the image sensor to detect the display outline and to determine the pointing direction of the image sensor with respect to the detected display outline.

The physical position of the image sensor can be adjusted so that the center point of an image taken by the image sensor is congruent with the focus point of the operator on the display shown within the image, when relative head-eye movements are small.

The effective pointing direction of the image sensor can be adjusted by software by adding a coordinate offset to an image taken by the image sensor.

Said means for initiating actions on the machine include a microphone and an audio processor mounted on the wearable apparatus or a microphone connected directly to the machine. Other means for initiating actions include detection of certain head movements such as rotation around the sensor pointing axis or rapid movements of small amplitude.

The described method provides feedback from the wearable apparatus to the machine, which is realized in the preferred embodiment as a wireless data link to a receiver that is connected to the machine.

A software driver installed on the machine positions the display pointer at coordinates determined by the processor and processes received audio data to recognize user commands and to initiate corresponding actions on the machine.

In another presented embodiment, the wearable apparatus primarily consists of the image sensor, the microphone and a transmitter to send image and audio data over a high bandwidth link to the machine, where a software driver processes audio and image data to recognize and execute user commands, to extract current pointer positions and to display the pointer at these positions. The microphone may be connected directly to the machine, in which case only image data is transferred over said data link.

A preferred embodiment additionally includes means for initiating actions consisting of a special keyboard driver that can be enabled or disabled by a keystroke of a dedicated key, such as the ALT key. When enabled, several keys of certain areas of the keyboard can be defined with the same function, such as CLICK for all keys on the left side and DOUBLECLICK for all keys on the right side, to eliminate the need for precise aiming to avoid having to take the view of the display. This method can be used in conjunction with audio commands described previously.

A preferred embodiment further includes means for facilitating display outline recognition by the processor or software driver by the use of a maximum of eight small adhesive infrared reflective stickers placed around the perimeter of the display and an infrared source positioned next to the image sensor. This reduces the computational power required by the processor or software driver. It also increases reliability of the pointing method, since no complex image processing algorithms are needed to detect a few reference objects around the display and yet, the reference points entirely define the display outline. The use of infrared light results in less irritation by ambient lighting conditions.

### DRAWINGS—FIGURES

FIGS. 1A to 1D show perspective views of a preferred embodiment of the wearable apparatus, including an exploded view of the telescopic arm that holds the image sensor.

FIGS. 2A and 2B show two preferred embodiments of the receiver apparatus.

FIG. 3 shows a working environment of the invention including a personal computer with keyboard, receiver and a monitor with attached reference objects and a target on the display.

FIG. 4 shows an operator wearing the sensor-apparatus and aiming on a target located on a display with light reflecting, adhesive reference objects, whereby the pointing direction of the sensor and the line of vision of the operator are shown as well as the pointer that is controlled.

FIGS. 5A and 5B show block diagrams of the wearable apparatus and the receiver apparatus, presenting the main components of the electric circuitry and their connections.

FIGS. 6A to 6D show images of the display environment taken by the image sensor, including the light reflecting reference objects around a display quadrant.

FIGS. 7A to 7D show images of the display environment taken by the image sensor and the display itself with light reflecting reference objects, whereby the figures illustrate coherences of sensor image and physical display area where the pointer is controlled.

FIGS. 8A to 8C show a flowchart describing the algorithm for determining absolute pointing coordinates for the display from images of the display environment including light reflecting objects positioned around the display outline.

FIGS. 9A and 9B show an alternative embodiment of the wearable apparatus and receiver apparatus in form of block diagrams.

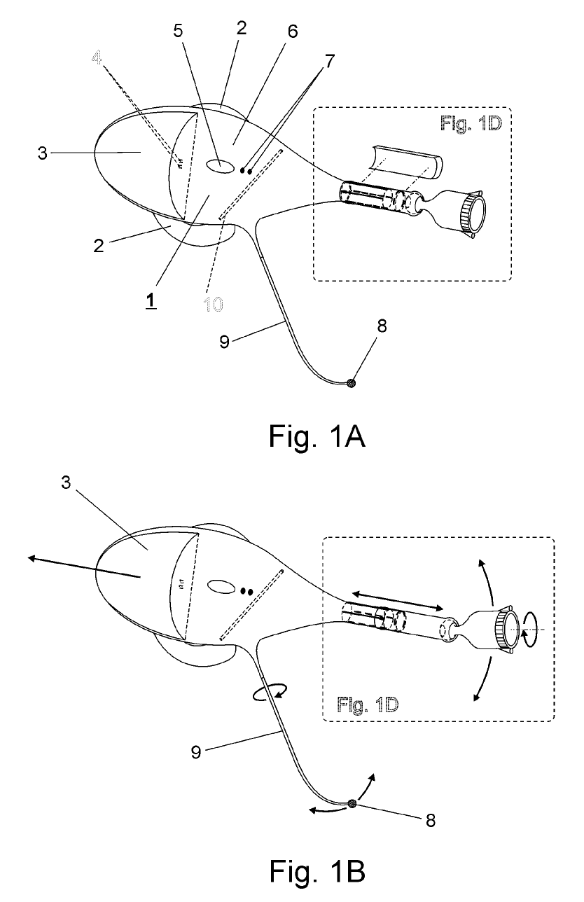

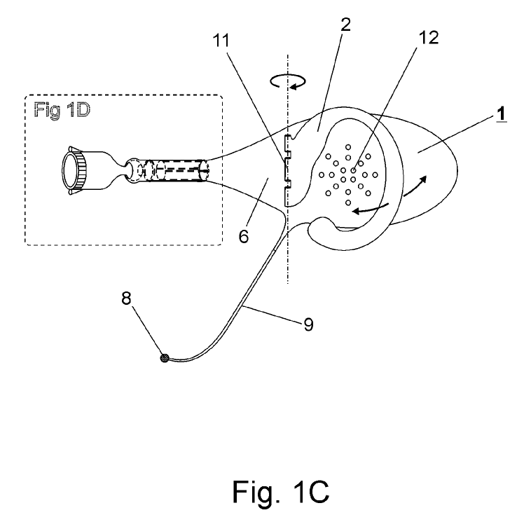

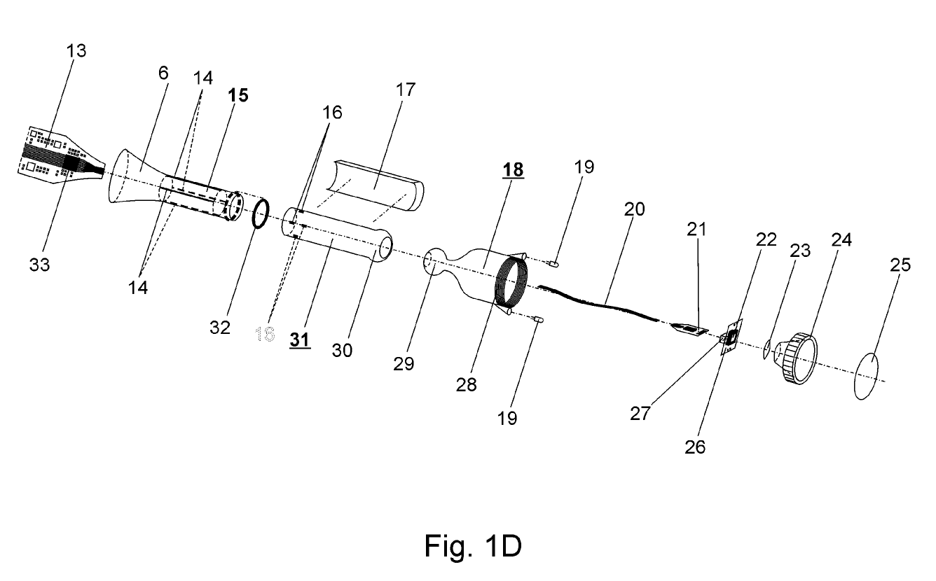

### DETAILED DESCRIPTION—FIGS. 1, 2, 3, 5—PREFERRED EMBODIMENT

FIGS. 1A-1D:

FIGS. 1A to 1D show a preferred embodiment of the form factor of the wearable apparatus in different perspective views. FIG. 1A shows the main body 6 containing electronic components and a rechargeable battery 3 inserted into the main body. The entire case of the apparatus is plastic or another lightweight material. The battery is detachable from the main body as indicated by the arrow in FIG. 1B and when inserted, it is connected to the electronic circuitry inside the main case over two contacts 4.

A C-shaped ear clip 2 is attached to the main body, best shown in FIG. 1C. The ear clip consists of a flexible wire, coated in a soft material like rubber or plastic and its shape is designed to fit around a human ear to hold the main body in a stable position next to the ear. It can be manipulated to fit an individual ear.

FIG. 1D shows a more detailed, exploded view of the front end of the preferred embodiment. The main body narrows to a tube 15 at the front end having four prolonged notches 14 indented along each side that serve as sliding guides for an outer plastic tube 31. This outer tube contains four notches 16 that fit into the indented notches of the inner tube. Together, the tubes form a hollow telescopic arm that can be extended or retracted as illustrated in FIG. 1B by sliding the outer tube over the inner tube, which is part of the main case. An O-ring 32 is positioned at the end of the inner tube to add friction and a tight fit between the tubes. The front end of the outer tube widens spherically to form part of a ball joint 30, over which a third tube 18 having a ball shaped end 29 is connected. On the other end, the third tube widens to hold a printed circuit board (PCB) 21 carrying a few electrical components and to which a flexible cable (FLEX) 20 containing a multiple of traces is connected at one end and another PCB 26 is connected over a PCB connector 27 at the other end so that the latter PCB is positioned perpendicular to the first PCB.

A system-on-chip (SOC) 22 consisting of an image sensor and processor is mounted on the PCB 26, whereby the active or photosensitive area of the image sensor is facing outward in the direction of the longitudinal axis of tube 18. The widened front end of tube 18 has a thread 28, onto which a conically shaped lens carrier 24 can be screwed. The lens carrier holds a lens 23 on the side facing the image sensor. The lens is positioned above the photosensitive area of the image sensor and the distance from the lens to the image sensor and thus, the focus point of the lens, can be changed by rotating or screwing the lens carrier inward or outward.

The outermost end of the lens carrier 24 holds an infrared filter 25.

Two infrared LEDs 19 are mounted in two openings of the widened tube 18 and are pointing along the longitudinal axis of the tube, whereby the LEDs are connected to PCB 26.

The flex cable 20 leads from the PCB 21 through all the tubes 18, 31 and 15 to the main PCB 13 contained in the main body 6 of the apparatus, connecting the image sensor SOC 22 and the infrared LEDs 19 with the digital signal processor (DSP) 33 located on the main PCB.

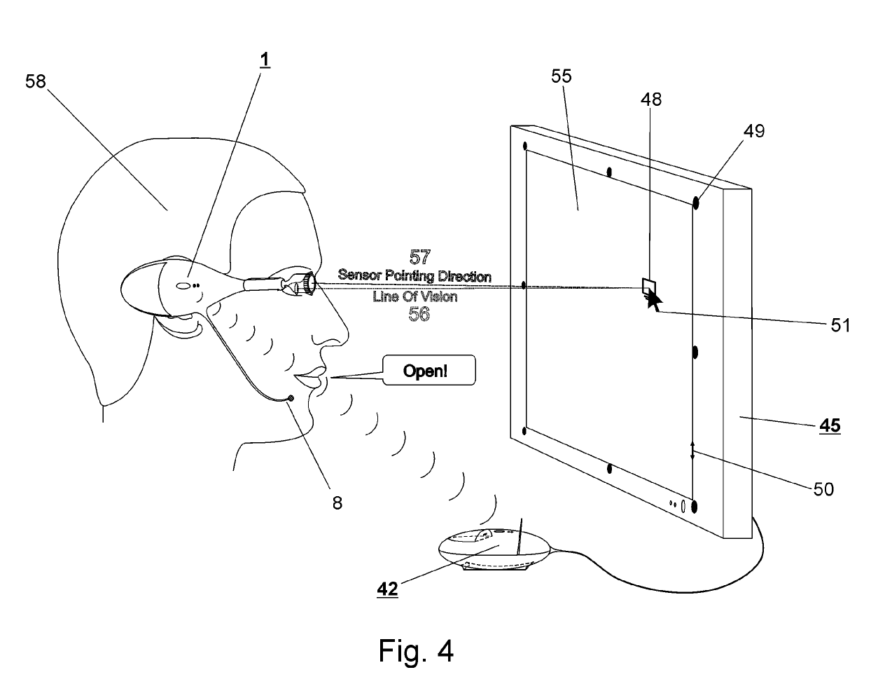

As shown in FIGS. 1B and 4, the length of the telescopic arm described above and the pointing direction or longitudinal axis of the tube holding the image senor can be adjusted such that the image sensor is positioned next to the eye of the operator 58 (FIG. 4) when the apparatus is worn on the ear. Fine adjustments can be made by rotating the image sensor over the ball joint 29-30 and by extracting or retracting the telescopic arm 15, 31. Ideally, these adjustments will position the image sensor in a manner so that the center point 106 (FIG. 7) of an image taken by the image sensor is congruent with the target 48 (FIG. 4) or focus point of the operator on the display 45 (FIG. 4) where the pointer is controlled, shown within the camera image (FIGS. 7A and 7C). Also, adjustments can be made preventing the operator's face from obstructing the line of vision from the lens to the display while the front end of the apparatus does not interfere with operator's view.

The apparatus, including the battery, is balanced in weight around the joint 11 (FIG. 1C) between the main body 6 and the ear clip 2 to hold it stable on the ear. A piece of foam material 17 (FIG. 1D) is attached to the outer tube 31 of the telescopic arm on the operator facing side to constitute an additional stabilizer when resting on the operator's temple to hold the apparatus stable. The ear clip 2 is a key element in holding the image sensor stable and close to the operator's eye. Different forms and shapes other than described previously can be used. Examples can be retrieved from special headsets such as wireless cellular phone headsets, since these headsets must solve similar weight and ergonomics problems.

Also attached to the main body is another flexible arm 9, consisting of a tube made of plastic or of a flexible material coated in plastic. On the front end of the flexible arm, a microphone 8 is integrated, which is connected to the main PCB 13 inside the main body 6 over two wires that run inside the arm. The arm carrying the microphone is flexible enough (FIG. 1B) so that the microphone can be positioned in front of the operator's mouth or near the operator's throat (FIG. 4). The microphone 8 can also be mounted inside the hollow flexible arm 9 closer to the main body 6, whereby the hollow arm acts as a sound wave guide.

A push button 5 is integrated into the main body to provide means for switching the apparatus on and off. LEDs 7 can be added to the main body to inform the operator of various operating states.

The apparatus has an antenna 10 or a convexity that surrounds a partially buried antenna at any location of the main body. Preferably, the entire antenna is contained in the main body with no convexity.

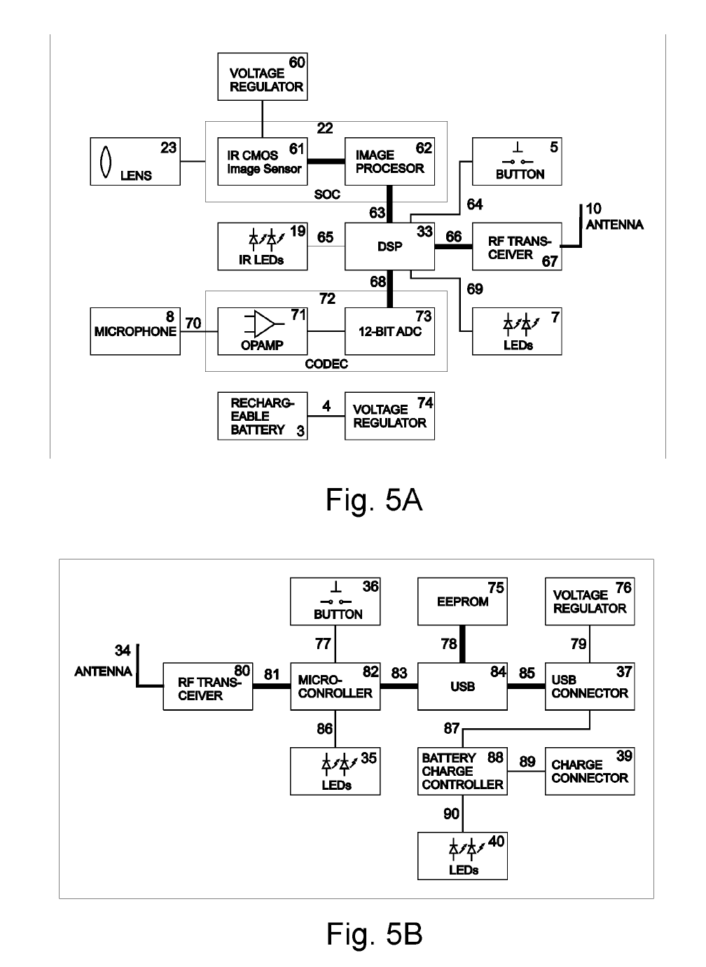

FIG. 5A:

FIG. 5 shows the essential components of two preferred embodiments in a block diagram.

FIG. 5A shows the preferred embodiment of the electronic circuitry for the wearable apparatus 1 (FIG. 1). The central element of the apparatus is a digital signal processor or DSP 33. The DSP is a high-performance, low-power; fixed-point digital signal processor such as the TMS320VC5501 from Texas Instruments. Other types of integrated circuits can be used instead of this DSP, such as FPGAs, ASICs or other DSPs. If a DSP is used, software is stored in the non-volatile memory of the processor and loaded and executed in RAM when

the processor is powered up. The DSP is running a few hundred million instructions per second (MIPS) to enable processing of at least 30 image frames per second at 320×240×1 6 bit resolution received from an image sensor and an eight-bit audio data stream with approximately 4'000 samples per second, while being clocked not much faster than absolutely required by the signal processing algorithm to keep power consumption as low as possible.

The apparatus further includes a color image sensor 61 (CMOS sensor with sensitivity for red, green and blue light components) with a maximum resolution of 668H×496V pixels (VGA). The sensor has a ¼ inch optical format and includes auto black compensation, a programmable analog gain, programmable exposure and low power, 10-bit ADCs. Its spectral response reaches into the infrared (IR) range with a relative spectral response of approximately 0.75 at 850 nm (1.0 being the maximum of any color).

A lens 23 within an aperture and an infrared optical filter (FIG. 1D) are mounted on top of the active area of the image sensor to provide good focus over a wide range as well as shielding ambient light from the sides and non-infrared light not near 850 nm.

The image sensor 61 can take up to 90 frames per second at 27 MHz clock frequency with a resolution of 320×240 pixels (QVGA) and is part of a system-on-chip (SOC) 22 that also incorporates an image processor 62 that performs various functions such as color correction, gamma and lens shading correction, auto exposure, white balance, interpolation and defect correction, and flicker avoidance.

The SOC is connected to the DSP over a 2-wire serial bus and an 11-wire parallel interface 63. It can be programmed to output various formats such as YCbCr (formerly CCIR656), YUV, 565RGB, 555RGB, or 444RGB. As described above, a lens 23 (FIGS. 5A and 1D) and an IR filter 25 (FIG. 1D) is mounted on top of the image sensor.

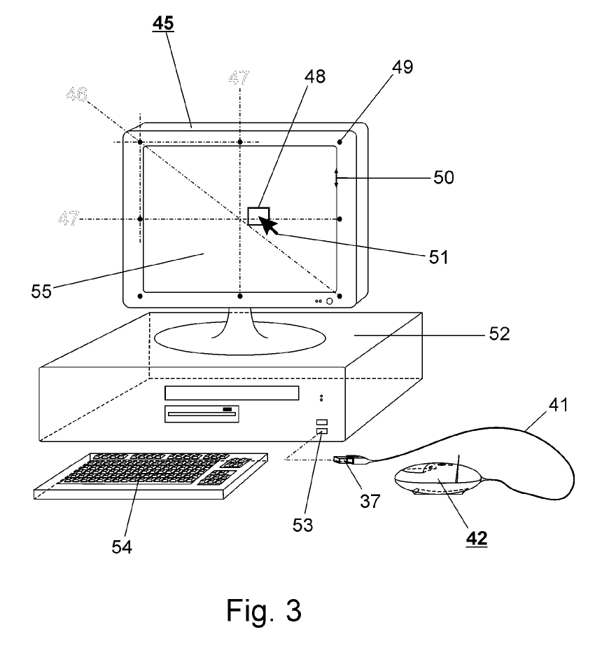

Next to the lens are two infrared light emitting diodes (IR LEDs) 19 (FIG. 5A, 1D), emitting light with a strong spectral component at 850 nm, which is reflected from objects 49 (FIGS. 3, 4 and 7) which are recognized by the image sensor as described later. The intensity of the IR LEDs is controlled over two output ports 65 of the DSP 33. The DSP controls the LED duty cycle to achieve an optimum tradeoff between power consumption and reliability of reference object detection.

A microphone 8 (FIG. 1A, 5A) is connected to an audio signal processor or CODEC 72 over two wires 70. The audio CODEC includes a signal amplifier 71 with adjustable gain, a BIAS voltage for the microphone and an analog to digital converter 73 with minimum of 12 bit resolution and with a programmable sampling rate up to 64'000 samples per second. Sample rate and amplitude resolution of the CODEC may vary and are subject to a signal-quality vs. bandwidth tradeoff. The CODEC is also connected to the DSP over a synchronous 8-bit serial port 68.

A radio frequency (RF) transceiver 67 is also connected to the DSP over a 13-pin interface 66 including two synchronous 3-wire serial interfaces for control and data signals. The transceiver can transmit and receive data. The preferred transceiver for this invention is the TRF9603 from Texas Instruments. An operating frequency of 915 MHz was chosen. Any frequency within the Industrial, Scientific and Medical Band (ISM) can be used. The modulation used is Frequency Shift Keying (FSK) and the output power can be adjusted from −12 dBm to +8 dBm with a maximum data rate of 64k bits per second. An antenna 10 (FIG. 1A, 5A) is connected to the RF transceiver. Various antenna types can be used for this application such as a dipole antenna. Preferably, the antenna can be integrated as a trace on the printed circuit board.

A single cell rechargeable battery 3 (FIGS. 1, 2 and 5A) is used to provide power to the apparatus. Various battery types can be used such as Li-ion or NiCad batteries, depending on charge cycle requirements, duration of use, weight, safety or environmental concerns. A Li-ion battery is used in the preferred embodiment of this invention. When inserted, the battery is connected to a voltage regulator 74 over two spring-loaded contacts 4 (FIG. 1A, 5A).

The voltage regulator generates a constant output voltage from the battery voltage to supply all active components and that suffices the power requirements of components using the supply. The voltage regulator consists of a linear low-dropout regulator that is active when the battery voltage is above the required output voltage and a switched regulator (step-up) that is active when the battery voltage is below the required output voltage. A second voltage regulator 60 is cascaded with the first regulator to generate a lower voltage required by the image processor. A switched step down regulator is used for high efficiency.

A push button 5 and two LEDs 7 (FIG. 1A, 5A) are each connected to an I/O port 64 and 69 of the DSP to provide means for turning the apparatus on/off and for user feedback.

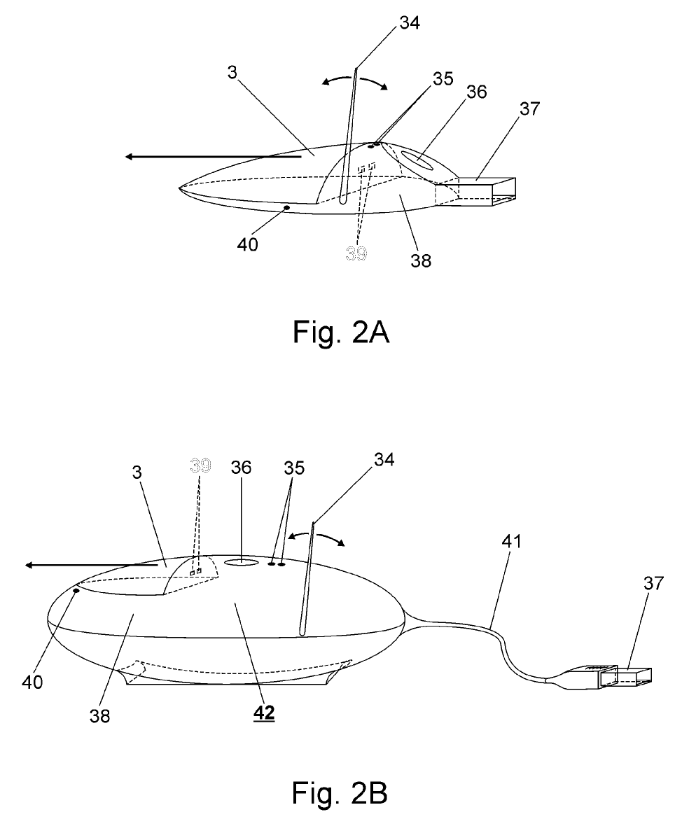

FIGS. 2A and 2B:

FIGS. 2A and 2B show two preferred embodiments of the receiver apparatus. The two embodiments presented are equivalent in their basic functionality. FIG. 2A shows a compact version of the receiver, intended for use with laptop computers or other mobile devices with a USB port. This version of the receiver apparatus plugs into the USB port directly, whereas the embodiment shown in FIG. 2B is intended to rest on a surface and is plugged into the machine connected to a display over a USB cable 41 with USB plug 37.

Both embodiments show the same components, consisting of a main plastic body 38 containing electronic components shown in block diagram of FIG. 5B. The main body has a section that is shaped like the inverse half-form of the rechargeable battery 3 (FIGS. 1 and 2) to form a cradle. Electric contacts 39 are positioned on one side of the cradle and will touch the contacts of the battery when it is inserted. The plastic body also hosts a multiple of LEDs 35 and 40 which are controlled by the electronic circuitry for user feedback and a push button 36. A USB connector 37 is located on one end of the body over which the apparatus can be connected to the machine 52 shown in FIG. 3 that is connected to the display 45 where the pointer 51 is controlled (personal computer). The user interface may be more extensive and include an LCD and buttons.

The apparatus has an antenna 34 or a convexity that surrounds a partially buried antenna at any location of the main body. Preferably, the entire antenna is contained in the main body 38 with no convexity. The antenna could also be mounted externally and connected to the main body by a joint to make its orientation adjustable as indicated by the arrows in FIGS. 2A and 2B.

FIG. 5B:

FIG. 5B shows the preferred embodiment of the electronic circuitry for the receiver apparatus on the basis of a block diagram.

The central element of the apparatus is a microcontroller (μC) 82. The microcontroller is a 16-bit RISC, ultralow-power mixed signal microcontroller such as the MSP430F122 from Texas Instruments with a serial communication interface (UART/SPI), multiple I/O ports, 4 kbyte FLASH memory and 256 byte RAM. Other types of integrated circuits can be used instead of this μC, such as FPGAs, ASICs or other microcontrollers. If a μC is used, software is stored in the non-volatile memory of the device and loaded and executed in RAM when the μC is powered up. The device is clocked at an appropriate frequency (maximum 8 MHz) to enable receiving of a synchronous serial data stream of approximately 34 kbit/s and sending the data stream to a USB chip 84 over another serial port while keeping power consumption as low as possible.

The USB chip or IC 84 is a serial-to-USB bridge, which is a system-on-chip containing a processor, an UART or I/O port and a USB transceiver. Other types of USB chips may be used and may be part of a system-on-chip that includes the functionality of the microcontroller. The UART or I/O port of the USB chip is connected to the microcontroller over an interface 83, comprising an UART or 8-bit I/O port (TTL or CMOS levels) and a few additional control lines. The IC 84 is powered by the USB bus. An external serial EEPROM 75 is connected to the USB chip over a serial interface 78 and is used to store a USB device identifier required by the USB driver on the host (PC). If the EEPROM is omitted, default settings stored in the USB chip will be used. A standard USB connector (plug) 37 is connected to the USB transceiver of the USB chip over a standard USB interface 85 and constitutes the interface to the machine 52 shown in FIG. 3 that is connected to the display 45 where the pointer is controlled (personal computer).

A radio frequency (RF) transceiver 80 is also connected to the microcontroller over a 13-pin interface 81 including two synchronous 3-wire serial interfaces for control and data signals. The transceiver can transmit and receive data. The preferred transceiver for this invention is the same as used with the DSP described previously (FIG. 5A). If another transceiver is used, it must be compatible with the one used in the wearable apparatus described previously. An antenna 34 (FIG. 2, 5B) is connected to the RF transceiver. Various antenna types can be used for this application such as a dipole antenna. Preferably, the antenna can be integrated as a trace on the printed circuit board.

A battery fast charge controller 88 for single or multi-cell Ni—Cd/Ni-MH or Li-ion batteries is connected to the USB power supply as indicated by connection 87. The charger is compatible with the type of rechargeable battery used in the wearable apparatus described previously. A preferred battery type used in this invention is a single cell Li-ion battery. One to three LEDs 40 are connected to the controller over an interface 90 for charge state user feedback. The controller may be stand-alone or connected to the microprocessor for feedback or configuration purposes. A buzzer can also be connected to the controller for feedback. The preferred charge controller in this invention is stand-alone and not connected to the microcontroller. Two spring loaded contacts 39 (FIG. 5B and FIG. 2) constitute the interface to the battery that needs to be charged and are connected to the controller by a two-wire interface 89.

A switched step down voltage regulator 76 is powered by the USB bus as indicated by connection 79. It supplies all components that can not be driven by the 5V USB bus, such as the microcontroller and RF transceiver.

A user interface for feedback of various device or transmission states is realized by connecting a two-color LED 35 to an output port 86 of the microcontroller. A more extensive user interface may be chosen such as an LCD.

A push button 36 is connected to an input pin 77 of the microcontroller to enable operator actions such as turning the device on/off, initiating calibration, etc.

FIG. 3:

FIG. 3 shows a preferred environment of the machine with display to be controlled. It consists of a personal computer (PC) 52 with USB port 53, a computer monitor 45 and a keyboard 54 connected to the PC.

As illustrated, eight infrared reflective stickers 49 are placed symmetrically and at known distances from each other around the display, tracing the border indicated by the arrows 50 of the active display area 55 as close as possible. The stickers consist of highly reflective material with an adhesive backside. Preferred material used in this invention is “Scotch Cube Corner Reflector” safety material from the 3M corporation. The preferred shape of the stickers is round with a diameter from 5 mm to 15 mm, depending on ambient lighting conditions. Other sizes and shapes may be used. Shapes should be symmetrical such that the color balance point lies in the center of the shape for high precision. One sticker is placed just outside each corner 46 of the active display area 55 and one exactly halfway 47 between the corner stickers on each side of the active display area. All distances must be accurate as pointer control relies on distances relative to these stickers. In order to keep distances between reference objects exact, aids may be provided for proper spacing such as removable adhesive interconnections between stickers.

The purpose of the stickers is to increase performance and most of all reliability of the invented pointing method, however, as component performance increases, a software algorithm may be used capable of display outline recognition (edge detection) without the use of reference objects such as reflective stickers.

FIG. 3 also shows the preferred embodiment of the receiver apparatus 42 connected to the Personal Computer 52 over a USB link 41 and 37.

The figure further illustrates a target 48 on the active display area such as a Microsoft Windows Desktop icon and a cursor 51 represented by an arrow located over the target.

Operation—FIGS. 4, 5, 6, 7 and 8

FIG. 4:

Due to the form factor of the wearable apparatus shown in FIG. 1, the pointing direction of the image sensor follows the pointing direction of the operator's head 58, specifically the pointing direction of the operator's eye area, which will closely follow the operator's line of vision 56 or focus point on any object 48 if the pointing direction of the image sensor center point is initially adjusted so that it is congruent with or closely correlated to the operator's focus point on the display, assuming relative head-eye movements are kept small.

FIG. 4 illustrates the operator's line of vision 56 and the sensor pointing direction 57 by hatched lines. The figure further shows the operator's aiming point or target 48, such as a desktop icon, on the active display area 55.

The cursor 51 follows the sensor pointing direction 57 with respect to the display outline defined by reference points 49 and thus, the cursor follows the line of vision 56 of the operator 58.

Humans naturally tend to move their eyes over greater angles than the head. Increasing head movements to compensate for greater eye movement to keep relative eye-head movements small have still been found very intuitive by several test subjects.

FIG. 7:

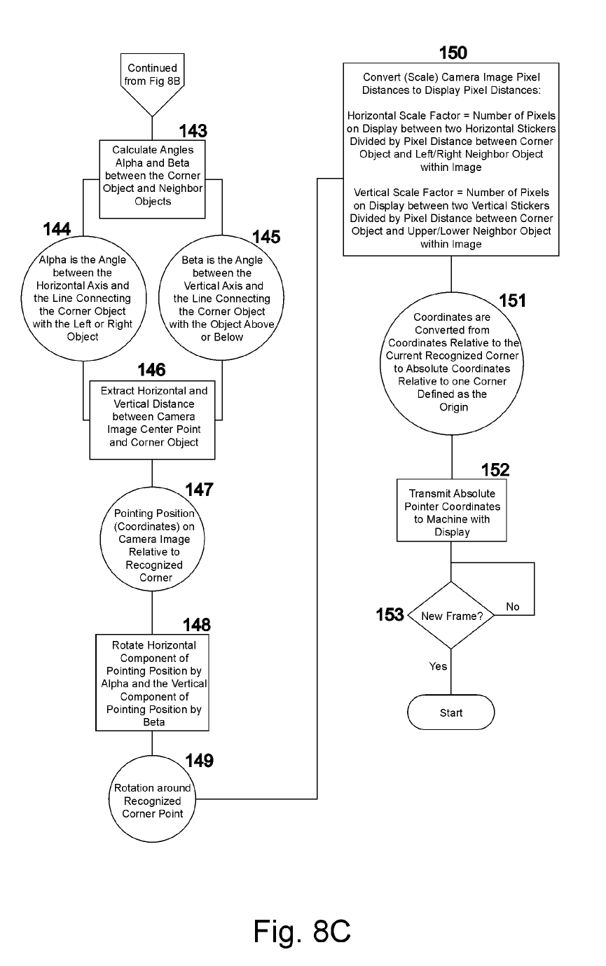

As illustrated in FIG. 7, the software algorithm (flow chart FIG. 8) on the DSP also compensates for distortions of cursor placement caused by angled views from the sides and rotations around the axis going into the display.

The system-on-chip 22 (FIG. 5A, 1D) containing the image sensor continuously takes images 103 of the display area where the pointer is controlled, thus, the center point 106 of each taken image is ideally congruent with the operator's focus point on the target 48 (FIG. 4 and FIG. 7) on the display area 55 (FIGS. 7B and 7D) appearing in the image as shown in FIGS. 7A and 7C. The image sensor takes 30 frames per second at a resolution of 320×240 pixels in the infrared range. The image sensor can also take color images in RGB format with red components in the infrared range; however the preferred embodiment of this invention uses information only in the infrared range (monochrome). Infrared was chosen because it is invisible to the human eye and it makes recognition of the reference points 49 within the image 103 less irritable by ambient light such as direct sun light.

The image data is sent to the DSP 33 (FIG. 5A), where the software algorithm (flow chart FIG. 8) extracts the current pointing coordinates on the display 45 by analyzing each image frame. FIGS. 7A and 7B or 7C and 7D, respectively, show that the true pointer coordinates on the display with the pointer can be calculated from an image 103 of the display area by the coordinates of the image center point 106 relative to at least one corner 96 of the display appearing in the image.

A corner is identified by recognition of at least three of the reference objects 49, consisting of small reflective adhesive stickers placed around the display corner reflecting IR light emitted from an LED light source 19 (FIG. 1D) next to the image sensor 22 (FIG. 1D). Using reference objects increases reliability and reduces the complexity of the software algorithm running on the DSP of the wearable apparatus and thus, reduces power consumption as well as component requirements.

Details of the DSP software algorithm are shown in the flowchart FIGS. 8A to 8C.

Thus, the cursor 51 will follow the pointing direction of the image sensor on the wearable apparatus relative to the display outline 50, which closely follows the operator's focus point if relative eye-head movements are kept small.

The pointing position is updated at least 30 times per second. The resulting pointing method is absolute and closely follows the operator's focus point without the need for constant position feedback and involvement of any body parts.

FIGS. 5A and 5B:

The image data from the image SOC 22 is streamed to the DSP 33 at a maximum data rate of 27 Mbps where the software algorithm (flowchart FIG. 8) calculates the true, absolute pointer coordinates on the active display area 55 (FIGS. 4, 7B and 7D) to position the pointer.

Once a target 48 (FIGS. 4 and 7) is hit with the pointer, commands are necessary to initiate certain actions. Commands (mouse click equivalents and more) are provided using the microphone 8, over which known or previously trained commands can be transmitted to the computer 52 shown in FIG. 3 (such commands may include “open”, “close”, “hide”, “show”, “cancel”, “drag”, “drop”, “on”, “off”, etc.) or by sounds such as blowing short once or twice or one time long. The microphone could also be implemented in the receiver apparatus of FIG. 2 instead of the wearable apparatus of FIG. 1.

The digital audio data stream from the CODEC 72 is also transmitted to the DSP at 32 kbps (4 kHz sampling rate, 8-bit amplitude resolution), where it is time-multiplexed with the pointer coordinates and sent to the transceiver IC 67 over a serial bus 66. Data is sent to the transceiver in packets of 1 40+6 (audio data and pointer coordinates) bytes, 30 times a second, to allow for inactive, low-power transceiver periods where power can be conserved.

The audio data stream consists of sampled voice or sound signals converted from acoustic to electrical signals by the microphone. The audio signals are generated when the operator speaks into the microphone or generates other sounds such as puffing or blowing over the microphone.

The transceiver 67 modulates the data and sends it wireless over a dipole antenna 10 to the transceiver 80 of the receiver apparatus depicted in FIG. 5B, which demodulates the signal and sends the data stream to the microcontroller 82.

The microcontroller forwards the data to the USB chip 84 over a synchronous serial link 83, from where it is sent to a USB port 53 (FIG. 3) of the PC over a USB connector 37 and cable 41 (FIG. 2B). Other functions of the microcontroller include initialization of the USB chip as well as control of a user interface consisting of LEDs 35 (FIG. 5B and FIG. 2) to indicate various RF and USB transmission states.

A software driver on the PC 52 (FIG. 3) analyses the data stream received over the USB port 53, de-multiplexes pointer coordinates and audio data and either forwards the audio data to another driver or application that recognizes and translates audio commands into commands understood by the operating system to initiate actions, such as mouse button action commands, or it performs the task itself. The driver also positions the display cursor 51 (FIGS. 3, 4 and 7) at the received coordinates.

Software solutions are commercially available or already part of an operating system that could be used in combination with a less complex driver, which only controls the pointer position and forwards the audio stream to the commercial software driver either directly or over a standard interface of the operating system, which initiates actions by voice command recognition. Such software is already available at low cost and implemented in certain operating systems such as Windows XP.

An alternate method of initiating actions on the personal computer is a method that doesn't use audio commands to initiate actions but a special keyboard driver residing on the PC 52 (FIG. 3). This method of initiating actions can be used in parallel with the method using audio commands described above. Since it is not very likely that the operator will initiate actions while the pointer is moved, the operator can assign one special and easy accessible key of the keyboard, e.g. an “alt” next to the large “space” key, over which the operator can switch between text input and pointing mode upon a key stroke. The keyboard functions as a normal keyboard while in text input mode. While in pointing mode, certain keys of the keyboard have certain functions to initiate actions like mouse buttons on a mouse. To avoid that the user needs to actually look down onto the keyboard to find a certain key, a function is assigned to a whole group of keys rather than just to a single key so that the user only needs to press a key within a certain function area and doesn't need to aim for a specific key. In doing so, the user can keep the view on the display most of the time.

As indicated in FIG. 1B, the battery 3 of the wearable apparatus can be detached and placed in the cradle of the receiver apparatus (FIG. 2), where it is recharged within a few hours. Recharging will take less time than the time it takes to discharge the battery during operation of the apparatus. Thus, one battery can always be recharged while the other battery is in use, which enables continuous operation of the apparatus. The preferred battery type of this invention is a Li-ion type, which shows characteristics that resists deterioration caused by a large number of charge cycles.

The battery charge controller 88 (FIG. 5B) used in the receiver apparatus may be run in different charge modes such as pulsed/constant current or pulsed/constant voltage fast charge. It monitors temperature, voltage, current and charge time. Charging is stopped when an error state occurs (e.g. temperature out of range) or when the battery voltage and temperature indicate fully charged. It detects the presence of a battery and automatically starts the charging procedure. The LEDs 40 are connected to and controlled by the charge controller 88 for user feedback of various battery-charging states such as charging, fully charged, charge error, etc.

Description of the Algorithm—FIGS. 5, 6, 7 and 8

Flow chart FIG. 8—The main function of the DSP software is to run an algorithm for determining current pointer positions, that is, analyzing the image data received from the image sensor 22 (processor or system-on-chip), recognizing the reference objects 49 (FIGS. 3, 4 and 7) described previously that define the display outline 50 (FIGS. 3, 4 and 7), determining the current absolute pointer position 51 (FIGS. 7B and 7D) on the display 45 from the detected display outline within an image and forwarding the coordinates to the PC over the data link described previously. Other functions comprise forwarding the audio data stream over 66 to the RF transceiver 67, initializing and controlling the image processor or SOC 22 and handling user interactions over the button 5. FIG. 8 only describes the algorithm for extracting the pointing position and not the other functions of the DSP software, since these are routine functions that don't need further explanation and depend on the specific hardware used (image processor 62, audio CODEC 72, RF transceiver 67).

Thus, FIG. 8 shows the flow of the main task performed by the algorithm running on the DSP 33 (FIG. 5A), divided into steps 111 to 153. As shown by step 111 in the flow chart, the DSP initially receives a pixel (16-bit RGB color value) from the image processor or system-on-chip (SOC), respectively. In step 112, the red, green and blue values (color mode) or intensity value (monochrome mode) are/is compared to each value of an array containing typical color or intensity values of a reference object 49 (FIGS. 3, 4). Reference objects are light reflecting stickers disposed around the display outline and are illuminated by a light source 19 (FIG. 1D) next to the image sensor.

If a match is found, the pixel is declared a suspect. If the current pixel value however does not match any of the values within said array, the pixel is discarded and the next pixel of the frame is processed. Typical values were determined iteratively for different lighting conditions. The values are stored fixed in memory. Actual lighting conditions can be determined from the automatic exposure and/or automatic white balance control setting of the image processor 62 (FIG. 5A).

If the pixel value matches a typical value found in reference objects at current lighting conditions and if the pixel coordinates lie within proximity of a previously found suspect (step 113), whereby proximity is defined by an object area, the pixel is assumed to belong to the same object as said previous pixel or group of pixels and pixel coordinates are added to the average coordinates of all pixels within the same object area and the standard deviation is calculated for each dimension (x,y) including the current coordinates (step 115). If no object area has been declared by a previous suspect pixel, the current pixel defines a new object area (step 114), extending in three directions (left, right and down) from the current pixel coordinates with a defined range or object radius. The object area should be large enough to include all pixels potentially belonging to a reference object but small enough to prevent that two reference objects can be contained within the same object area, considering different display sizes and distances from the image sensor to the display.

When the current pixel coordinates have left the current object area (step 118), two conditions must be met in order to ultimately confirm a potential object within the area (step 117). As a first condition, the number of suspect pixels within the declared object area must exceed a certain threshold (step 116). Secondly, the standard deviation of the pixel coordinates of all suspect pixels within the object area must be below a certain other threshold (step 120). This second criteria takes into consideration that an object appears as a heap or group of concentrated suspect pixels and pixels belonging to an object are not spread out over a large area. Other criteria may be added such as shape recognition of reference objects or color identification of multicolor reference objects. Both thresholds can be iteratively determined for different lighting conditions and depending on the size of the reference objects used. The threshold values can be stored within the memory of the signal processor. The object is considered unconfirmed and is discarded (step 119) if not both conditions above are met.

To increase processing performance, a search radius around a found suspect pixel could be defined that is much smaller than the object area. Thus, if the threshold criteria are applied to pixels within the search radius only and if the criteria are met, it is not necessary to further process pixels that lie outside the search radius within the object area, since no more than one reference object can be contained within the object area if the size of the area was chosen wisely. For small search radii, the standard deviation criterion may be neglected. If the criteria are not met within a search area, a new search area will be created within the same object area if another suspect pixel is found within the area.

If an object was confirmed, its coordinates are set equal to the sum of all suspect pixels contained within the object area (step 121). Further (steps 122, 123, 124), the x- and y-coordinates of the current object are compared to the coordinates of all previously found objects of the same image frame. The first pixel of a frame is the origin with x=y=0 and corresponds to the upper left image corner.

If the x-component of the object is smaller than the x-coordinate of all previous objects, the object is the left outermost object. Likewise, if the x-component of the object is greater than the x-coordinate of all previous objects, the object is the right outermost object. The same method is used to determine whether the current object is the highest or lowest object within the current image frame by comparing the y-coordinate of the object to the y-coordinates of all previous objects.

The process above is repeated until the last pixel of the image frame has been received and processed (step 125).

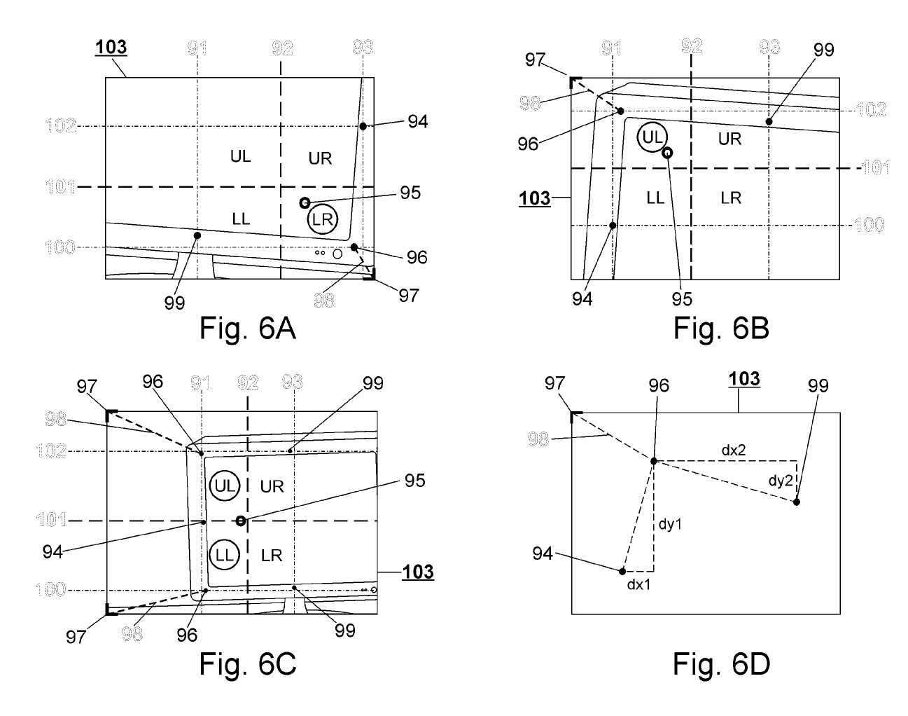

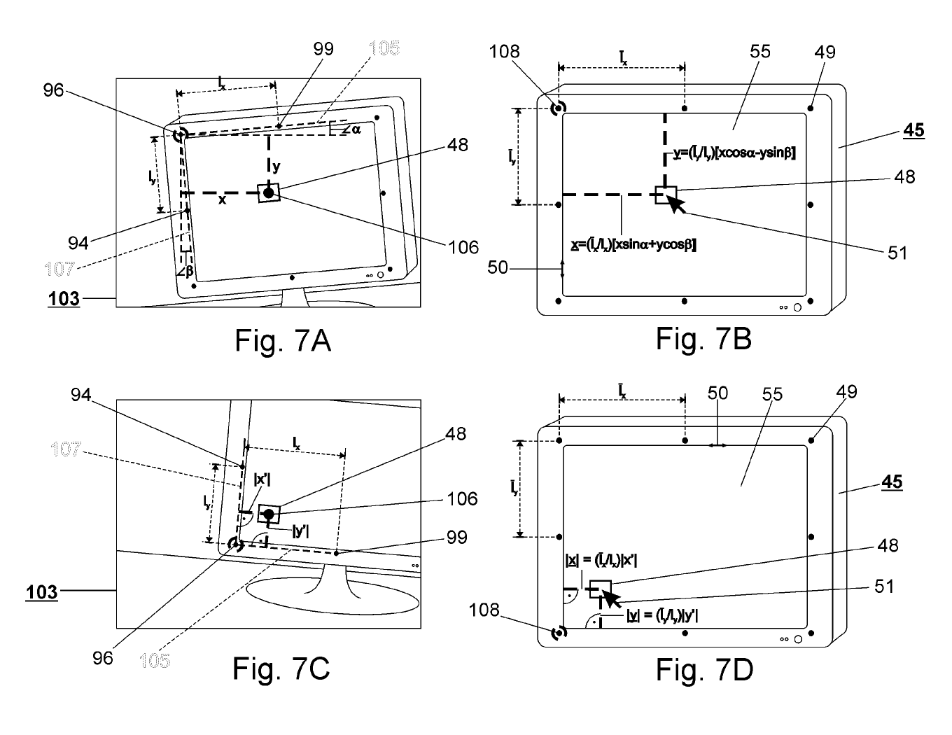

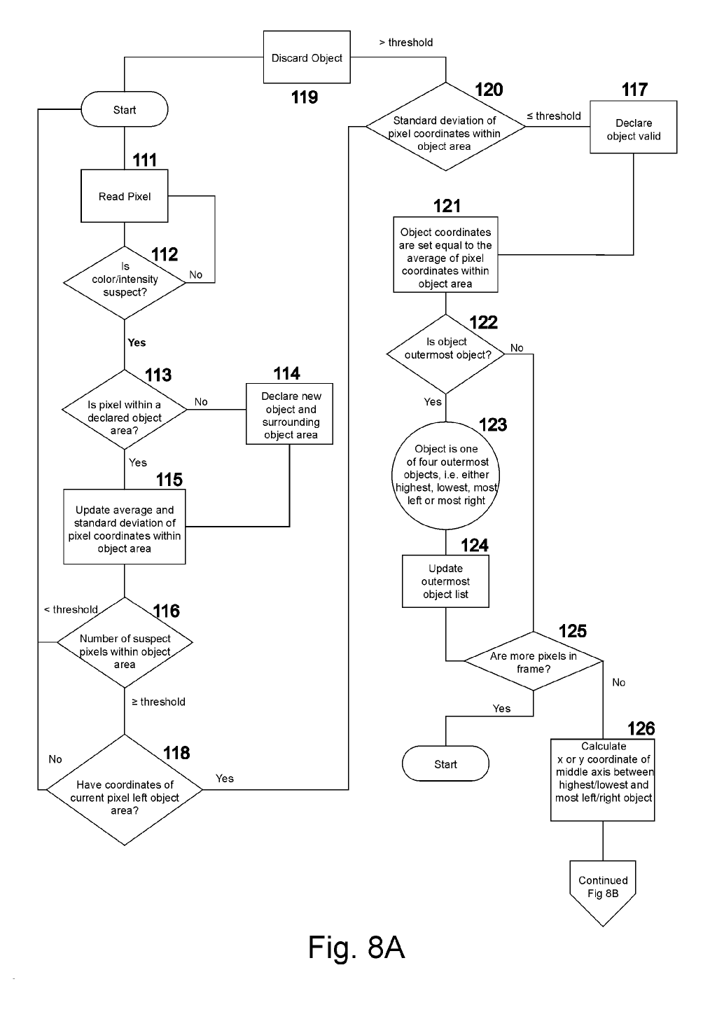

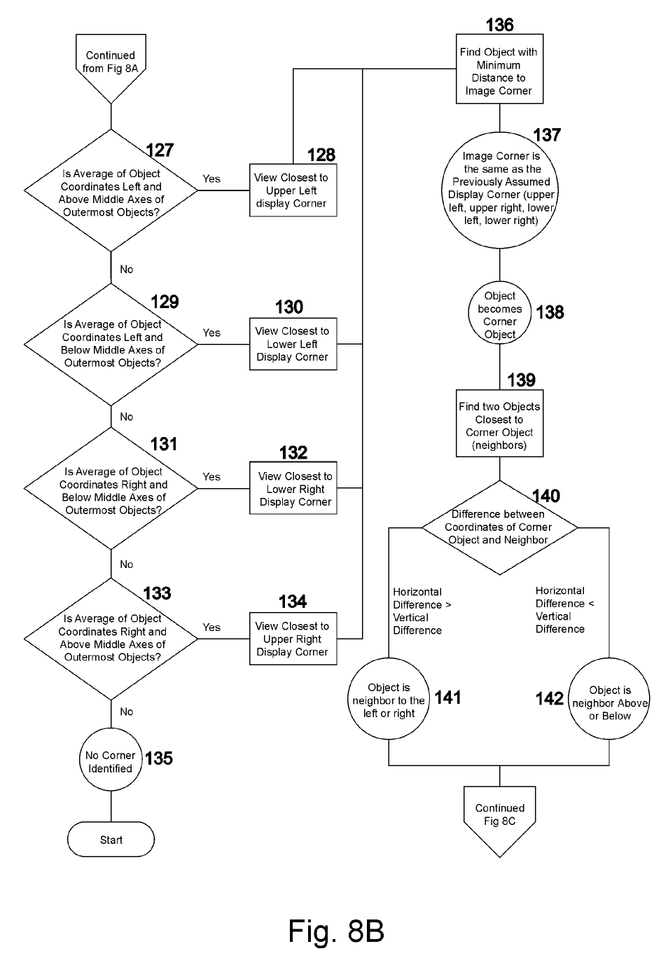

If at least one object was identified, it is determined onto which quadrant (upper left, upper right, lower left or lower right) of the display area 55 (FIGS. 6 and 7) the image sensor is pointing as illustrated in FIG. 6.

FIGS. 6 and 8—In order to achieve this task, two steps are performed by the algorithm.

First, the vertical middle-axis 92 between the x-coordinate of the most left object (object lying on axis 91) and most right object (object lying on axis 93) is calculated by averaging the x-coordinates of the two outermost objects (step 126). The most left object has the smallest x-coordinate of all objects within the frame; the most right object has the greatest x-coordinate of all objects. In the same manner, the horizontal middle-axis 101 between the y-coordinate of the highest object (object lying on axis 102) and lowest object (object lying on axis 100) is calculated by averaging the y-coordinates of the highest and lowest object (step 126). The highest object has the smallest y-coordinate of all objects within the frame; the lowest object has the greatest y-coordinate of all objects.

Second, the balance point 95 of all recognized objects within the image frame is calculated by averaging all object coordinates. This object balance point is then compared to the position of the previously determined middle axes between outermost objects which reveals the quadrant of the active display area where the image sensor is currently pointing to (steps 127 through 135).

In order to successfully determine a quadrant on the display 45 (FIG. 7), all three reference points within the quadrant must have been recognized. The reference objects within a quadrant consist of a corner reference object 96, a first neighbor object 99 that is horizontally aligned to the corner object and a second neighbor object 94 that is vertically aligned to the corner object. FIGS. 7B and 7D show the corresponding corner reference objects 108 on the actual display 45, rather than their images 96 within an image 103.

For example, if the sensor is pointing to the upper left quadrant as shown in FIG. 6B, at least three reference objects must be recognized. One will be the upper left corner object 96, one will be the neighbor object below 94 (located in middle of left display side) and one the neighbor to the right 99 of the corner object (middle of upper display side). Therefore, the previously described middle axes 92 and 101 split the quadrant into four octants as indicated in FIG. 6 by UL (upper left octant), UR (upper right octant), LL (lower left octant) and, LR (lower right octant). The balance point 95 of the three objects will be in the upper left octant (UL), since two objects on the left 94, 96 and upper side 96, 99 “weigh” more than only one object 99 on the right and one object 94 on the bottom. Thus, left octant described above equals upper left quadrant of the display.

However, as shown in FIG. 6C it is not crucial which quadrant is recognized. As long as one quadrant UL or LL is successfully recognized, the corner object 96 within this quadrant can be used as reference point or origin even if the current pointing direction lies outside the recognized display quadrant.

However, at least one corner reference object must be recognized with at least one horizontally and one vertically aligned neighbor. This requires the image sensor 61 (FIG. 5A) to have a certain angle of view, depending on the display size, number of reference objects 49 and the distance from the operator 58 (FIG. 4) to the display.

A simple formula can be used to determine minimum sensor angles of view, assuming eight reference objects as described previously: Minimum horizontal angle=2*arctan(“display area width” 1(2*“distance sensor to display”)) Minimum vertical angle=2*arctan(“display area height”/(2*“distance sensor to display”))

If angles are not met, the distance from the operator (or image sensor) to the display must be increased. The sensor angle of view can be changed using different lenses 23 (FIG. 1D). Wide-angle lenses can be used to reduce the number of required reference objects around the display outline (e.g. only one object in every corner) or to significantly reduce the requirement regarding the minimum distance from the sensor to the display. However, the wider the lens angle, the greater the optical distortion, which needs to be compensated by the algorithm if it becomes so great that significant precision is lost.

Once three reference objects and their corresponding quadrant were identified within an image frame, the algorithm identifies the corner points 96 as well as the two neighbors, one aligned rather horizontally 99 and one rather vertically 94 with respect to the corner object, assuming rotations around the image sensor pointing axis don't exceed approximately 20 degrees for a right rotation or 33 degrees for a left rotation. These angle limitations arise from the 4/3 display ratio (x-resolution vs. y-resolution, e.g. 1 024×768) and the fact that for angles above these maxima, the balance point of three objects crosses the middle axes between outermost objects and thus, quadrants will be misidentified.

The corner object 96 within the identified display quadrant is the object with minimum distance 98 (FIG. 6) to the image corner point 97 corresponding to the identified display quadrant, i.e. upper left image corner if the upper left quadrant was identified, etc., whereby the distance to an image corner 97 is the square root of the sum of the squared x- and squared y-component between an object and the image corner 97 (steps 136-138).

As shown in FIG. 6D and steps 139-142 in the flow chart (FIG. 8B), the type of a neighbor object is identified by the ratio of the horizontal distance (dx1 for 94, dx2 for 99) between neighbor and corner object to the vertical distance (dy1 for 94, dy2 for 99) between neighbor and corner object. If the horizontal distance (dx) is greater than the vertical distance (dy), the object is a horizontally aligned neighbor 99 (step 141), i.e. to the left of the corner object, if the x-coordinate of the neighbor is smaller than the x-coordinate of corner object or to the right of the corner object, if the x-coordinate of the neighbor is greater than the x-coordinate of the corner object. If the vertical (dy) distance is greater than the horizontal (dx) distance, the object is a vertically aligned neighbor 94 (step 142), i.e. above the corner object, if the y coordinate of the neighbor is smaller than the y-coordinate of corner object or below the corner object, if the y-coordinate of the neighbor is greater than the y-coordinate of the corner object.

FIG. 7:

When corner and neighbor objects were identified, the algorithm compensates for rotations of the image sensor around its pointing axis with respect to the display. First, the angle alpha (α) shown in FIG. 7A between the horizontal (x-) image axis and the line connecting the corner object and the left or right corner object 105 is determined (steps 143, 144). Second, the angle beta (β) between the vertical (y-) image axis and the line connecting the corner object and the object above or below 107 is determined (steps 143, 145). Third, the image sensor pointing position relative to a corner is extracted by subtracting the coordinates of the corner object 96 from the image center point 106 coordinates (steps 146, 147).

The next steps (148, 149) involve rotation of the horizontal (x-) component of the pointing coordinates by angle alpha and the vertical (y-) component of the pointing coordinates by angle beta. Thus, the pointing position 106 is rotated around the corner object (96, step 149) or in other words, the vectors between the corner object and its two neighbors are transformed so that they span an orthogonal vector space within the image with the corner object as origin and one horizontal and one vertical base vector.

The rotation is described by the formula:
v=A·v
with
v=[x y]^{T}; coordinates within an image of the display area—FIG. 7A
v=[x y]^{T}; coordinates on the display area where the pointer is controlled—FIG. 7B
A=[sin(α) cos(β)cos(α)−sin(β)]; two-dimensional rotation matrix

FIGS. 7C and 7D illustrate the above in another way for the lower right display corner by looking at vector lengths or pixel distances only.

The use of two separate angles will make the base vectors orthogonal and accounts for angled views from the side of the display to some degree.

The next step (150) involves scaling of the sensor image pixel coordinates or distances to pixel coordinates or distances on the display where the pointer is controlled. A horizontal line (x-direction) connecting two reference objects 49 (corner 96 and horizontal neighbor 99, after rotation) within an image 103 must be scaled so that its transformed line, if drawn on the display area 55 with the current display resolution, would connect the corresponding real reference objects 49 placed around the display (in contrast to its images within the sensor image), if the reference object stickers were placed exactly around the outline of the active display area. Since reference objects 49 are positioned slightly outside the active display area 55, the scaling factors must be slightly corrected. This can be done during an initial calibration. The same scaling is used for a vertical line connecting two reference objects 49 vertically (corner 96 and vertical neighbor 94, after rotation) within an image.

Thus, the two orthogonal base vectors or the x- and y-coordinate of the rotated pointing position 106, respectively, must be scaled according to the formulas:

x-component:
x=x*(pixel distance between two horizontal reference objects on display at current display resolution)/(pixel distance between the same reference objects within image)
y-component:
v=y*(pixel distance between two vertical reference objects on display at current display resolution)/(pixel distance between the same reference objects within image)
whereby
x, y are the pixel coordinates within an image of the display area in reference to the orthogonal coordinate system (after rotation was performed)
x, y are the pixel coordinates within the display area where the pointer is controlled

Thus, FIG. 7 illustrates the rotation and scaling of the image center point 106 or sensor pointing direction with respect to the display outline defined by reference objects 49 and shows the coherences of sensor image and display area where the pointer is controlled.

In the final step (151), coordinates relative to a specific corner need to be converted to absolute display coordinates relative to the display origin defined by the operating system or driver on the PC 52 (FIG. 3). The absolute pointing coordinates are then forwarded to the transceiver 67 (FIG. 5A, flowchart step 152) from where they are transmitted to the PC 52 (FIG. 3) where the software driver places the cursor on the display area 55 at the corresponding position. After completion of this last step, the DSP algorithm enters an idle state until the first pixel of the next image frame is received (step 153).

Note that the DSP software algorithm in FIG. 7 and thus, the wearable apparatus described in the preferred embodiment require that the display resolution of the display area 55 (FIG. 7) where the pointer is controlled is known in order to perform coordinate scaling. Preferably, the software driver on the PC 52 (FIG. 3) retrieves this information from the operating system over an appropriate software interface and forwards this information to the DSP 33 (FIGS. 1D, 5A) on the wearable apparatus over the bi-directional RF link defined by elements 67-10-34-80 (FIG. 5) as described previously and presented in FIG. 5. The scaling of the pointing coordinates described in the software algorithm (FIG. 7 and FIG. 8C) could also be performed by the software driver on the PC, which has access to the current display resolution information.

For the most intuitive use, the pointing method described in the preferred embodiment requires initial adjustment of the image sensor position using described mechanisms shown in FIG. 1D to superimpose cursor position and focus point of the operator. This adjustment must likely be repeated before every use or whenever necessary. On the other hand, an adjustment can be made by moving the cursor by software means to superimpose the cursor with the focus point of the operator, provided that the physical image sensor pointing direction is reasonably close to the line of vision of the operator.

### Alternative Embodiments

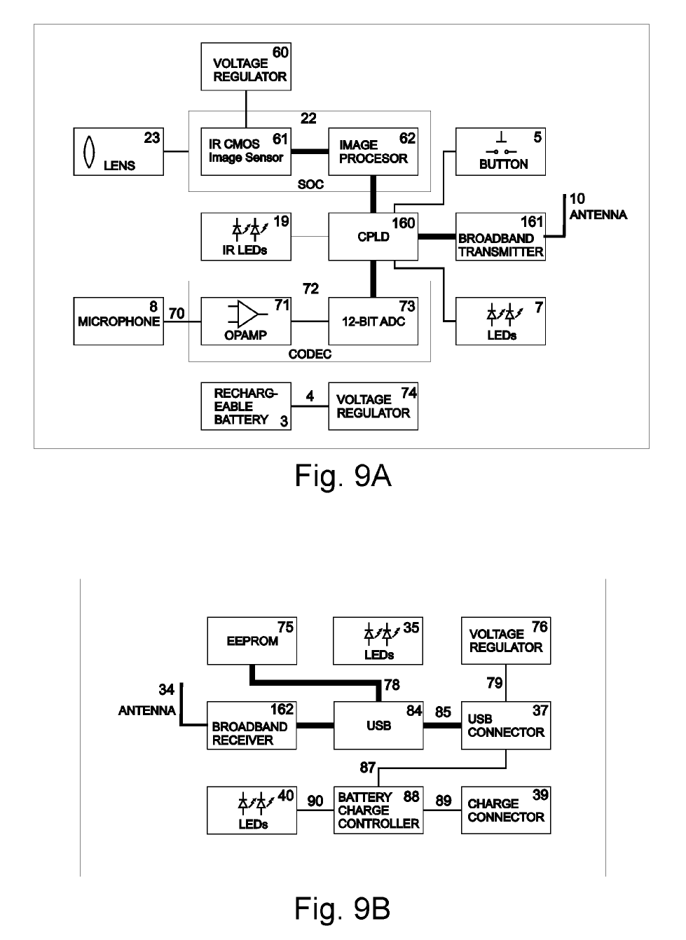

There are many possibilities for alternate embodiments and method variations of the invention, some of which are described below. FIG. 9 shows one alternative embodiment in form of a block diagram. Other embodiments and method variations are described while not being additionally supported by a figure due to the large number of variations possible with this invention.

FIG. 9—The signal processing implemented on the DSP 33 (FIG. 5A) can theoretically be implemented on the computer in the device driver, however, currently the required technology to achieve the signal bandwidth to enable transmission of at least 30 pictures per second is expensive and/or very power consuming. Thus, the purpose of the signal processor is to reduce the data amount to be transmitted to the computer and to minimize the complexity of the device driver required on the computer. Future versions of the devices described in the preferred embodiment may consist of less complex and more cost effective devices while performing the digital signal processing on the personal computer. FIG. 9 shows the corresponding block diagram of an alternative embodiment of the invented pointing method. Like the preferred method described previously, it consists of a wearable apparatus (FIG. 9A) and a receiver apparatus (FIG. 9B). One significant difference is that the DSP 33 (FIG. 5A) is replaced by a cheaper and less power consuming high-speed integrated circuit 160, such as a CPLD, FPGA, ASIC, microcontroller or another digital control unit, that directly sends the image and audio data to a high bandwidth RF transmitter 161 without further data processing. The transmitter constitutes part of a broadband wireless link, such as wireless USB. The digital control unit 160 may be part of a system-on-chip including the image sensor 61 and processor 62. A high bandwidth receiver 162 on the receiver apparatus (FIG. 9B) receives the data and forwards it directly to the USB chip 84 without the use of a microcontroller 82 (FIG. 5B). The data is then sent to the PC where the software driver runs the algorithm shown in FIG. 8 to extract the pointer position on the display and to interpret audio commands. This eliminates the need for an expensive DSP and is likely to reduce power consumption, size and weight of the wearable apparatus.

Data can be transmitted by other means than radio frequencies. An optical link such as high-speed IrDA or simply a cable could be used.

The described method of display outline recognition by reference objects such as reflective stickers 49 shown in FIGS. 3, 4 and 7 contributes to image processing speed, pointing precision and reliability of the DSP software algorithm. However, as DSP performance increases, an edge detection algorithm can be used to detect the display outline without the use of reference points.

Depending on the angle of view of the image sensor, as few as two reference objects placed at a precise distance from each other may be used instead of eight reference objects around the active display area.

The invention may also work with light in the visible range and reflective stickers of different color, depending on ambient conditions. Also, shape recognition may be used instead of or in conjunction with intensity or color recognition.

The microphone 8 (FIG. 1, 5A) can be implemented either on the wearable apparatus 1 (FIG. 1) or on the receiver apparatus shown in FIG. 2 and FIG. 5B.

Other possibilities for initiating actions may comprise finger buttons, special keyboard functions, foot pedals or optical sensors that detect the blinking of one or both eyes of the operator. In the latter case, the sensor may either be implemented on the receiver apparatus or positioned close to an eye of the operator next to the image sensor. It may consist of an infrared light beam and a photo sensor detecting the reflection of the light beam in the operator's eye. If the operator blinks with an eye, the light beam is interrupted, triggering an event.

The wearable pointer may be worn on other body parts that can be used for pointing. The apparatus could be worn on the wrist and the camera mounted on a finger to enable pointing onto displays or screens with a finger.

For people with certain disabilities, a virtual keyboard on the display can be used in combination with the presented pointing method to enter text solely using the pointer and simple user commands without the use of a keyboard. The virtual keyboard could be enabled or disabled by a simple voice command.

Means for initiating actions on the machine connected to a display may comprise detection of specific head movements and translation into user commands or detection of head rotations around the image sensor's pointing axis. Left and right rotations can be differentiated and interpreted as single click and double click action or an action list can be displayed on the display from which the operator can select a specific action as long as the head rotation is maintained.

Two cameras may be worn to enable stereo view and to determine the distance from the image sensors to the display where the pointer is controlled to further increase accuracy.

An audio speaker 12 (FIG. 1C) can be embedded in the earpiece, over which the operator can listen to radio, a wireless audio stream or any audio source connected to the earpiece optically or by a wire or over an uplink from the PC to the wearable apparatus.

The pointing method may be used on other devices such as pocket PCs or PDAs or with gaming devices such as Microsoft X-box or Sony Play-Station.

The correlation between the effective image sensor pointing direction and line of vision of the operator can be accomplished by a software calibration, initiated e.g. by voice or sound or keyboard commands or by using a mouse, to initially align the pointer with the focus point of the operator on the display. Thus, the physical image sensor pointing direction must only be set to capture the display area of the display where the pointer is controlled. This may result in the telescopic arm described above and shown in FIG. 1D, including the ball-joint 29-30, being replaced by a fixed arm. It needs to be determined if this correlation method is as intuitive as directly correlating the physical image sensor pointing direction with the operator's line of vision.

The presented wearable apparatus 1 (FIG. 1A) could be merged with a cellular phone or headset for a cellular phone (e.g. wireless Bluetooth headset), to increase ergonomics for mobile working environments.

Another embodiment of the receiver apparatus shown in FIG. 2A and FIG. 2B could include a connector to a telephone, whereby the wearable apparatus 1 (FIG. 1A) including the microphone 8 and the speaker 12 (FIG. 1C) could replace the part of a phone containing a microphone and speaker. Audio data received from the microphone of the wearable apparatus 1 (FIG. 1) can be converted on the receiver apparatus (FIG. 2) to an appropriate voltage level and transmitted to the telephone over said connector.

Audio data received over the telephone can be converted on the receiver apparatus (FIG. 2) to an appropriate voltage level and digitally sent from the receiver apparatus to the wearable apparatus, where the data is converted and sent to the speaker 12 (FIG. 1C).

Other means for facilitating display outline recognition may be provided such as contrast lines in various materials, colors, mounting methods, etc. and placed around the active display area 55 (FIG. 3) or in one corner of the display 45 (FIG. 3).

From the description above, a number of advantages of my method of controlling a machine connected to a display become evident:
(1) By use of an absolute pointing method and close correlation of pointer or cursor positioning to the line of vision of the operator, this pointing method is much more intuitive in use than methods of prior art. The method is very precise and fast due to the type of sensor used (CMOS or CCD image sensor).
(2) Since the pointer closely follows the focus point of the operator, no body parts are involved in pointing and no constant visual feedback or hand-eye coordination is needed to aim for a target.
(3) A machine such as a PC or laptop computer can be operated without having to switch between text input and pointing device such as keyboard and mouse. This creates a highly ergonomic user environment.
(4) Since the sensor of the pointing device is worn on the head moving along with the line of sight or line of vision of the operator and is not at a fixed position, restrictions regarding operating range, sensor field of view and posture of the operator or distance of the operator's head to the display are far less than in most of the prior-art.
(5) The wearable device is very small so that it can be worn on the operator's ear. No large and/or heavy headsets are required and no light reflecting stickers need to be placed on the operator's head.
(6) Only one sensor is required and no sensors need to be placed with respect to the display where the pointer is controlled.
(7) Audio commands, specifically voice commands, can be used to initiate actions and no buttons are required. If hands are positioned at a keyboard, special keyboard functions can be used instead of audio commands to avoid distraction of people in the proximity.
(8) No desktop space is needed to place objects like mouse pads.
(9) The presented method enables people with certain disabilities to control machines such as personal computers or gaming machines if they are in control of their head movements.

A functional prototype was developed. Although its functionality was not fully developed to the extent described above, the highly intuitive and precise nature of this pointing method could be confirmed.

### CONCLUSION, RAMIFICATIONS, AND SCOPE

Accordingly, the reader will see that the presented invention provides a highly effective, precise and intuitive method of controlling computers, gaming devices, projectors and other machines with a display or connected to a display without the need for sensors on the machine or the display itself.

Further, no additional space requirements exist and requirements for operating range are very small.

The pointing method further enables people with certain disabilities to control a machine.

In addition, preferred embodiments can be realized at low cost, light weight and in small sizes, whereby these parameters are expected to rapidly become smaller as standard, high-volume components and sensors can be used for this invention that experience a rapid downward trend mainly in cost and size while performance is expected to increase significantly.

While my above description contains many specificities, these should not be construed as limitations on the scope of the invention, but rather as an exemplification of one preferred embodiment thereof. Many other variations are possible. For example, the wearable apparatus can be smaller than the presented embodiment and have different shapes, it can be mounted onto eyeglasses or used with a light headset for additional stabilization; the electronic component count can be reduced by limiting it to components necessary for image data transmission only and implementing data processing on the machine that is controlled; a fixed arm can be used instead of a telescopic arm, if the sensor line of vision is not obstructed; the microphone can be directly connected to the machine that is controlled; different image sensors can be used with different resolutions, different spectral responses in the visible or invisible range, sensors can be monochrome or color with different numbers of colors; different image sampling rates can be used other than 30 frames per second, preferably higher; a wire can be used instead of a wireless link; different methods for detecting the display outline can be used such as various edge detection methods, eliminating the need for reference objects; other means than audio commands for initiating actions can be used such as the keyboard, foot pedals, eye- or head movement detection or methods triggered by blinking of an eye, buttons or wearable accelerometers to detect movements of a body part.

Accordingly, the scope of the invention should be determined not by the embodiment(s) illustrated or described, but by the appended claims and their legal equivalents.

What is claimed is:

1. A method of controlling a machine connected to a display, comprising: providing a wearable apparatus disposed on a human head comprising an image sensor, said image sensor having a pointing direction; first means for identifying the pointing direction of said image sensor with respect to said display; an operator having a line of vision or line of sight, second means for correlating the pointing direction of said image sensor with the line of vision or line of sight of the operator; third means for feedback from said wearable apparatus to said machine; fourth means for controlling a program running on said machine comprising the pointing direction of said image sensor with respect to said display, whereby said program running on said machine is controlled by means comprising the line of vision of the operator with respect to said display.

2. The method of claim 1, wherein said second means for correlating the pointing direction of said image sensor with the line of vision of the operator comprises means for adjusting the pointing direction of said image sensor so that said pointing direction follows the line of vision of the operator with respect to said display.

3. The method of claim 2 wherein said means for adjusting the pointing direction of said image sensor comprises mechanical means for adjusting the physical pointing direction of said image sensor.

4. The method of claim 3, wherein said mechanical means for adjusting the physical pointing direction of said image sensor comprises said image sensor being mounted on an arm adjustable in length and orientation providing said image sensor disposable next to an operator's eye and said arm being mounted on said wearable apparatus.

5. The method of claim 2 wherein said means for adjusting the pointing direction of said image sensor comprises electrical means for adjusting the effective pointing direction of said image sensor including electrical means for adding an offset to an image taken by said image sensor.

6. The method of claim 2 wherein said means for adjusting the pointing direction of said image sensor comprises optical means for adjusting the line of sight of said image sensor.

7. The method of claim 2 wherein said means for adjusting the pointing direction of said image sensor comprises software means for adjusting the effective pointing direction of said image sensor including the addition of a coordinate offset to an image taken by said image sensor.

8. The method of claim 1, wherein said wearable apparatus comprises said image sensor disposed on an ear of the operator.

9. The method of claim 1, wherein said wearable apparatus is disposed on eyeglasses.

10. The method of claim 1, wherein said wearable apparatus is disposed on a headset.

11. The method of claim 1, wherein said first means for identifying the pointing direction of said image sensor with respect to said display comprises a processor or integrated circuit running an algorithm and said display having an outline and an environment.

12. The method of claim 11, wherein said algorithm is running on said processor located on said wearable apparatus.

13. The method of claim 11, wherein said algorithm is running on said processor located on said machine connected to said display.

14. The method of claim 11, wherein said processor running an algorithm provides means for detecting the outline of said display within an image of the display environment taken by said image sensor and means for determining the position of the center point of said image relative to the outline of said display detected within said image.

15. The method of claim 14, wherein at least two light reflecting objects are disposed around the outline of said display at a predetermined distance and a light source is disposed next to said image sensor and said processor running an algorithm provides means for recognizing said light reflecting objects within an image to determine said display outline.

16. The method of claim 15, wherein said light is infrared light and said light source is at least one infrared LED.

17. The method of claim 15, wherein said light reflecting objects are adhesive stickers.

18. The method of claim 14, wherein said algorithm comprises an edge detection algorithm.

19. The method of claim 1, providing a CMOS image sensor.

20. The method of claim 1, providing a charge coupled device or CCD image sensor.

21. The method of claim 1, wherein said third means for feedback from said wearable apparatus to said machine includes a wireless link, comprising a wireless transmitter included in said wearable apparatus and a wireless receiver being connected to said machine.

22. The method of claim 1, wherein said third means for feedback from said wearable apparatus to said machine includes a cable containing wires.

23. The method of claim 1 and said third means for feedback from said wearable apparatus to said machine providing feedback to said machine, wherein said fourth means for controlling a program running on said machine further comprises means for responding to said feedback on said machine.

24. The method of claim 23, wherein said means for responding to said feedback on said machine comprises a software driver.

25. The method of claim 23, wherein said means for responding to said feedback on said machine is part of an operating system running on said machine.

26. The method of claim 23, wherein said means for responding to said feedback on said machine is part of said program running on said machine.

27. The method of claim 1, wherein said fourth means for controlling a program running on said machine further comprises means for controlling a pointer on said display.

28. The method of claim 1, wherein said fourth means for controlling a program running on said machine further comprises means for initiating actions on said machine.

29. The method of claim 28, wherein said means for initiating actions on said machine comprises a microphone and an audio processor included in said wearable apparatus and using said third means for feedback to transmit audio commands to said machine.

30. The method of claim 28, wherein said means for initiating actions on said machine comprises a microphone connected to said machine.

31. The method of claim 28, wherein said means for initiating actions on said machine comprises buttons using said third means for feedback to transmit button states to said machine.

32. The method of claim 28, wherein said means for initiating actions on said machine comprises a light source directed at said display and means for turning said light source on and off and said image sensor detecting reflections of said light source on said display.

33. The method of claim 28, wherein said means for initiating actions on said machine comprises means for detecting head rotations around the pointing axis of said image sensor.

34. The method of claim 1, wherein said machine is a computer having a keyboard and said fourth means for controlling a program running on said machine comprises a keyboard driver through which functions can be assigned to different keys for initiating actions on said machine, including enabling and disabling said method of controlling a machine by a key stroke of a dedicated key.

35. The method of claim 1, wherein said display is a computer monitor.

36. The method of claim 1, wherein said display is a television screen.

37. The method of claim 1, wherein said machine is a computer.

38. The method of claim 1, wherein said machine is a personal digital assistant or PDA.

39. The method of claim 1, wherein said machine is a gaming machine.

40. A method of controlling a machine connected to a display by the focus point or aiming point of the operator on said display, comprising: providing an apparatus comprising an image sensor disposed on a human head following the movements of said head and said image sensor having a pointing direction; first means for identifying the pointing direction of said image sensor with respect to said display; second means for correlating the pointing direction of said image sensor with the focus point or aiming point of the operator on said display; third means for feedback from said apparatus to said machine; fourth means for controlling a program running on said machine comprising the pointing direction of said image sensor with respect to said display, whereby said program running on said machine is controlled by means comprising the line of vision of the operator, whereby said line of vision projected onto said display approximates the focus point or aiming point of the operator on said display.

41. The method of claim 40, wherein said second means for correlating the pointing direction of said image sensor with the focus point or aiming point of the operator on said display comprises means for adjusting the pointing direction of said image sensor so that said pointing direction follows the line of vision or line of sight of the operator.

42. The method of claim 41 wherein said means for adjusting the pointing direction of said image sensor comprises mechanical means for adjusting the physical pointing direction of said image sensor.

43. The method of claim 42, wherein said mechanical means for adjusting the physical pointing direction of said image sensor comprises said image sensor being mounted on an arm adjustable in length and orientation providing said image sensor disposable next to an operator's eye and said arm being mounted on said apparatus.

44. The method of claim 41 wherein said means for adjusting the pointing direction of said image sensor comprises electrical means for adjusting the effective pointing direction of said image sensor including electrical means for adding an offset to an image taken by said image sensor.

45. The method of claim 41 wherein said means for adjusting the pointing direction of said image sensor comprises optical means for adjusting the line of sight of said image sensor.

46. The method of claim 41 wherein said means for adjusting the pointing direction of said image sensor comprises software means for adjusting the effective pointing direction of said image sensor including the addition of a coordinate offset to an image taken by said image sensor.

47. The method of claim 40, wherein said apparatus comprises said image sensor disposed on an ear of the operator.

48. The method of claim 40, wherein said apparatus is disposed on eyeglasses.

49. The method of claim 40, wherein said apparatus is disposed on a headset.

50. The method of claim 40, wherein said first means for identifying the pointing direction of said image sensor with respect to said display comprises a processor or integrated circuit running an algorithm and said display having an outline and an environment.

51. The method of claim 50, wherein said algorithm is running on said processor located on said apparatus.

52. The method of claim 50, wherein said algorithm is running on said processor located on said machine connected to a display.

53. The method of claim 50, wherein said processor running an algorithm provides means for detecting the outline of said display within an image of the display environment taken by said image sensor and means for determining the position of the center point of said image relative to the outline of said display detected within said image.

54. The method of claim 53, wherein at least two light reflecting objects are disposed around the outline of said display at a predetermined distance and a light source is disposed next to said image sensor and said processor running an algorithm provides means for recognizing said light reflecting objects within an image to determine said display outline.

55. The method of claim 54, wherein said light is infrared light and said light source is at least one infrared LED.

56. The method of claim 54, wherein said light reflecting objects are adhesive stickers.

57. The method of claim 53, wherein said algorithm comprises an edge detection algorithm.

58. The method of claim 40, providing a CMOS image sensor.

59. The method of claim 40, providing a charge coupled device or CCD image sensor.

60. The method of claim 40, wherein said third means for feedback from said apparatus to said machine includes a wireless link, comprising a wireless transmitter included in said apparatus and a wireless receiver being connected to said machine.

61. The method of claim 40 and said third means for feedback from said apparatus to said machine providing feedback to said machine, wherein said fourth means for controlling a program running on said machine further comprises means for responding to said feedback on said machine.

62. The method of claim 40, wherein said fourth means for controlling a program running on said machine further comprises means for controlling a pointer on said display.

63. The method of claim 40, wherein said fourth means for controlling a program running on said machine further comprises means for initiating actions on said machine.

64. The method of claim 40, wherein said machine is a computer having a keyboard and said fourth means for controlling a program running on said machine comprises a keyboard driver through which functions can be assigned to different keys for initiating actions on said machine, including enabling and disabling said method of controlling a machine by a key stroke of a dedicated key.

65. A method of controlling a machine connected to a display, comprising: providing an apparatus disposed on a human body part following the movements of said body part and said apparatus having a pointing direction; first means for identifying the pointing direction of said apparatus with respect to said display; second means for feedback from said apparatus to said machine; third means for controlling a program running on said machine comprising the pointing direction of said apparatus with respect to said display, whereby said program running on said machine is controlled by means comprising the movements of said body part with respect to said display.

66. The method of claim 65, wherein said apparatus disposed on a human body part is disposed on a human head.

67. The method of claim 66, wherein said apparatus is disposed on an ear.

68. The method of claim 66, wherein said apparatus is disposed on eyeglasses.

69. The method of claim 66, wherein said apparatus is disposed on a headset.

70. The method of claim 65 with said display having an outline and an environment, wherein said first means for identifying the pointing direction of said apparatus with respect to said display comprises an image sensor disposed on said apparatus taking images of said display and its environment, further comprising a processor or integrated circuit running an algorithm.

71. The method of claim 70, wherein said algorithm is running on said processor located on said apparatus.

72. The method of claim 70, wherein said algorithm is running on said processor located on said machine connected to said display.

73. The method of claim 70, wherein said processor running an algorithm includes means for detecting the outline of said display within an image of the display environment taken by said image sensor and means for determining the position of the center point of said image relative to the outline of said display detected within said image.

74. The method of claim 73, wherein at least two light reflecting objects are disposed around the outline of said display at a predetermined distance and a light source is disposed next to said image sensor and said processor running an algorithm provides means for recognizing said light reflecting objects within an image to determine said display outline.

75. The method of claim 74, wherein said light is infrared light and said light source is at least one infrared LED.

76. The method of claim 74, wherein said light reflecting objects are adhesive stickers.

77. The method of claim 73, wherein said algorithm comprises an edge detection algorithm.

78. The method of claim 65, wherein said second means for feedback from said apparatus to said machine includes a wireless link, comprising a wireless transmitter included in said apparatus and a wireless receiver being connected to said machine.

79. The method of claim 65 and said second means for feedback from said wearable apparatus to said machine providing feedback to said machine, wherein said third means for controlling a program running on said machine further comprises means for responding to said feedback on said machine.

80. The method of claim 65, wherein said third means for controlling a program running on said machine further comprises means for controlling a pointer on said display.

81. The method of claim 65, wherein said third means for controlling a program running on said machine further comprises means for initiating actions on said machine.

82. The method of claim 65 providing a display containing a cathode-ray tube or CRT, wherein first means for identifying the pointing direction of said apparatus with respect to said display comprises means for detecting a beam emitted from said CRT, further comprising means for correlating the point in time when said beam is detected to the pointing position of said apparatus on said display.
